(19) United States
(12) Patent Application Publication
(10) Pub. No.: US 2017/0129754 A1
(43) Pub. Date: May 11, 2017

(54) LIFT TRUCK HAVING IMPROVED CARRIAGE ASSEMBLY THAT INCLUDES INTEGRAL WEIGHING APPARATUS

(71) Applicant: CHICAGO MEASUREMENT, L.L.C., VOLO, IL (US)

(72) Inventor: JOHN GREGORY PANGRAZIO, VOLO, IL (US)

(73) Assignee: CHICAGO MEASUREMENT, L.L.C., VOLO, IL (US)

(21) Appl. No.: 15/346,964

(22) Filed: Nov. 9, 2016

Related U.S. Application Data
(60) Provisional application No. 62/252,649, filed on Nov. 9, 2015.

(51) Int. Cl. B66F 9/075; G01G 19/08

(52) U.S. Cl. CPC B66F 9/07504; G01G 19/083

(57) ABSTRACT

A lift truck includes a carriage assembly that is situated on a lift mechanism of the lift truck and which includes a first support, a second support, and one or more linear motion bearings, along with a weighing apparatus. The first support is situated between the masts of the lift truck, and the linear motion bearings and weighing apparatus are likewise situated between the masts of the lift truck. The second support is the frontal plate of the lift truck which is situated directly adjacent the masts and to which the forks of the lift truck are mounted. The result is that the weighing apparatus is situated rearward of the frontal plate of the lift truck and is situated between the masts of the lift truck, thereby avoiding the need to reduce the weight rating of the lift truck once the weighing apparatus is incorporated therein

### CROSS-REFERENCE TO RELATED APPLICATION

The instant application claims priority from U.S. Provisional Patent Application Ser. No. 62/252,649 filed Nov. 9, 2015, the disclosures of which are incorporated herein by reference.

### BACKGROUND

Field

The disclosed and claimed concept relates generally to lift trucks and, more particularly, to a lift truck having an integrated weighing apparatus.

Related Art

Numerous types of cargo transportation systems are known in the relevant art. One type of cargo transportation system is a lift truck of the type that is used to lift a workpiece from a first supporting surface at a first location and to transport the workpiece to a second location where it is lowered onto a second supporting surface. The one supporting surface might be the bed of a truck, and the other supporting surface might be the cargo hold of a cargo airplane, by way of example.

The shipment of cargo, i.e., workpieces, typically requires knowing the weight of the workpiece, i.e., the mass of the workpiece as learned from measuring its weight. The weight of each workpiece is needed for various reasons, such as for billing of the individual who shipped the workpiece, for helping to safely and efficiently load a truck or airplane, etc., and for other reasons. It thus has been known to retrofit existing lift trucks with scales of one kind or another. Such retrofitted scales typically are mounted to the front plate of an existing lift truck by removing the forks from the front plate, mounting the scale to the front plate, and then mounting the forks to another structure of the scale situated in a frontal direction from the pre-existing front plate.

While such scales have been generally effective for their intended purposes, they have not been without limitation. Since such retrofitted scales are mounted to the front plate of an existing lift truck, and because the forks are then subsequently mounted to the scale, the forks of the retrofitted lift truck are situated on the lift truck a distance forward of where they previously had been situated. The result of moving the forks forward results in the workpiece and thus the loading therefrom being situated relatively farther forward of a counterweight of the lift truck than was originally intended. This is undesirable because it results in the load carrying capability of the retrofitted lift truck being reduced. Effectively, the load rating of a retrofitted lift truck is reduced beyond what it otherwise would have been in the absence of the scale. As a result, it has been known to purchase relatively more expensive lift trucks having an initially higher weight rating which would subsequently be reduced to an acceptable weight rating once the scale was retrofitted thereon. Additionally, the placement of the scale and other structures on the front of the existing front plate of the lift truck added significant weight to the lift truck, thereby reducing efficiency. Improvements thus would be desirable.

### SUMMARY

Accordingly, an improved lift truck includes a carriage assembly that is situated on a lift mechanism of the lift truck and which includes a first support, a second support, and one or more linear motion bearings, along with a weighing apparatus. The first support is situated between the masts of the lift truck, and the linear motion bearings and weighing apparatus are likewise situated between the masts of the lift truck. The second support is the frontal plate of the lift truck which is situated directly adjacent the masts and to which the forks of the lift truck are mounted. The result is that the weighing apparatus is situated rearward of the frontal plate of the lift truck and is situated between the masts of the lift truck, thereby avoiding the need to reduce the weight rating of the lift truck once the weighing apparatus is incorporated therein.

Accordingly, an aspect of the disclosed and claimed concept is to provide an improved lift truck having a carriage assembly that incorporates a weighing apparatus behind the frontal plate and between the masts of the lift truck.

Another aspect of the disclosed and claimed concept is to provide an improved lift truck having a weighing apparatus without the need to additionally reduce its load rating.

Another aspect of the disclosed and claimed concept is to provide an improved lift truck having an integrated weighing apparatus that reduces cost and complication.

As such, an aspect of the disclosed and claimed concept is to provide an improved lift truck, the general nature of which can be stated as including a chassis, a pair of masts that are elongated and that are situated on the chassis, the pair of masts can be generally stated as including a first mast and a second mast that are spaced apart from one another, a lift mechanism situated on the chassis, a carriage assembly situated on the lift mechanism and that can be generally stated as including a first support, a second support, at least a first linear motion bearing, and a weighing apparatus, the first support being situated between the first mast and the second mast and being situated on the lift mechanism, the pair of masts permitting movement of the first support with respect to the pair of masts along the longitudinal extent of the pair of masts, the pair of masts at least partially resisting movement of the first support with respect to the pair of masts in directions other than along the longitudinal extent of the pair of masts, a number of forks situated on the second support and being structured to carry a workpiece. The at least first linear motion bearing that can be generally stated as including a first portion and a second portion, the at least first linear motion bearing permitting movement of one of the first portion and the second portion with respect to the other of the first portion and the second portion along a direction of movement, and the at least first linear motion bearing at least partially resisting movement of the one of the first portion and the second portion with respect to the other of the first portion and the second portion in directions other than along the direction of movement, the first portion being affixed to the first support, the second portion being affixed to the second support. The weighing apparatus can be generally stated as including a scale that is connected with at least one of the first support and the second support and that is structured to be subjected to loading from the second support based at least in part upon a weight of the workpiece.

### BRIEF DESCRIPTION OF THE DRAWINGS

A further understanding of the disclosed and claimed concept can be gained from the following Description when read in conjunction with the accompanying drawings in which:

FIG. 1 is a perspective view of an improved lift truck in accordance with the disclosed and claimed concept;

FIG. 2 is a schematic depiction of a portion of a carriage assembly of the lift truck of FIG. 1;

FIG. 3 is a schematic depiction of a portion of a lift mechanism of the lift truck of FIG. 1;

FIG. 4A is a side view of a linear motion bearing of the carriage assembly;

FIG. 4B is a top plan view of another linear motion bearing of the carriage assembly;

FIG. 5 is a perspective view of a portion of the carriage assembly;

FIG. 6 is a perspective view, partially exploded, of a portion of the carriage assembly;

FIG. 7 is another perspective view of the portion of the carriage assembly shown in FIG. 6, unexploded; and

FIG. 8 is a schematic top plan view of the lift truck.

Similar numerals refer to similar parts throughout the specification.

### DESCRIPTION

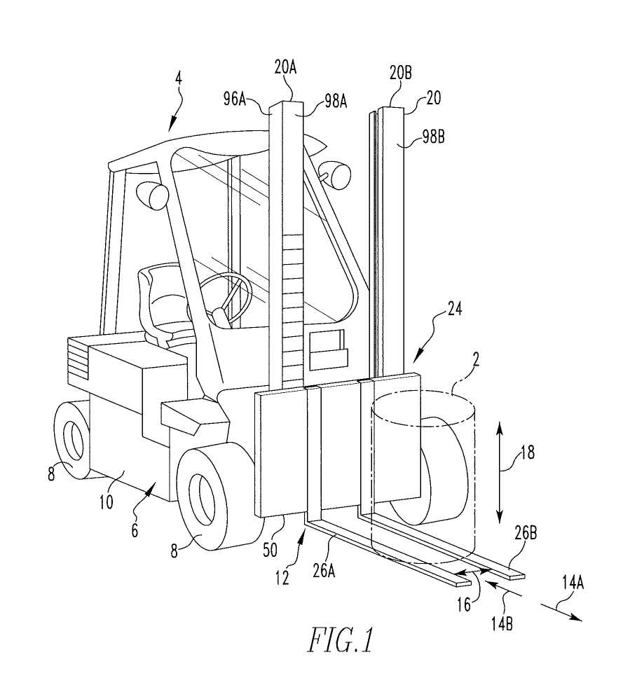

An improved lift truck 4 is depicted in FIG. 1 as including a chassis 6 having a number of wheels 8 and as further having an engine 10 situated thereon that powers the wheels 8 and the other systems of the lift truck 4. As employed herein the expression “a number of” and variations thereof shall refer broadly to any non-zero quantity, including a quantity of one. As will be understood by one of ordinary skill in the art, the lift truck 4 is advantageously usable to lift and transport a workpiece 2 from one location to another in a facility such as a warehouse or other facility. As will be set forth in greater detail below, the lift truck 4 advantageously has integral thereto a system that can weigh the workpiece 2, i.e., assess the mass of the workpiece 2 based upon its weight, and this property of the workpiece 2 (which is depicted in dashed lines in FIG. 1) can be used for any of a wide variety of purposes.

The lift truck 4 further includes an engagement apparatus 12 that is situated on the chassis 6 and that includes an exemplary pair of forks 26A and 26B that are operable to lift and lower the workpiece 2 along a vertical direction 18. The vertical direction 18 includes generally the up direction and the down direction. Furthermore, the engine 10 is operable to rotate the wheels 8 to cause the lift truck 4 to move along a longitudinal direction 14 which can be said to include a frontal direction 14A and a rearward direction 14B. Moreover, the wheels 8 in the depicted exemplary embodiment include a pair of steerable wheels which, when operated in conjunction with the engine 10 to move the lift truck 4 along the longitudinal direction 14, are usable to steer the lift truck 4 along a lateral direction 16. The longitudinal, lateral, and vertical directions 14, 16, 18 are mutually orthogonal in the depicted exemplary embodiment.

The engagement apparatus 12 can be said to include a pair of masts 20A and 20B (which may be individually or collectively referred to herein with the numeral 20) that are situated on the chassis 6 and a lift mechanism 22 that is also situated on the chassis 6. The engagement apparatus 12 further includes a carriage assembly 24 that is mounted on the lift mechanism 22 and the aforementioned pair of forks 26A and 26B (which may be individually or collectively referred to herein with the numeral 26). The masts 20 are elongated along a direction of elongation and are configured to permit movement of the carriage assembly 24 along the longitudinal extent of the masts 20 while generally resisting movement of the carriage assembly 24 in directions other than along the longitudinal extent. When the masts 20 are oriented in the vertical direction 18, the vertical direction 18 and the longitudinal extent of the masts 20 are generally parallel, but it is understood that the engagement apparatus 12 further includes a tilt mechanism that enables the pair of masts 20 to be rotated in the fore and aft directions (which would be a rotation generally about the lateral direction 16) and additionally are pivotable in the left and right directions (which would be rotation about the longitudinal axis 14).

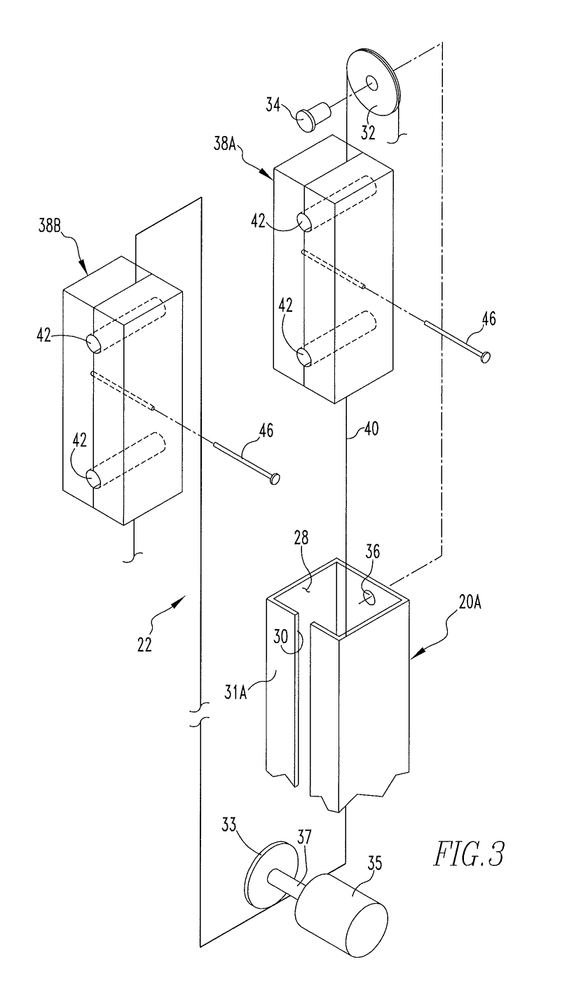

As can be best understood from FIG. 3, the masts 20 each have an elongated interior region 28 formed therein and further have an elongated slot 30 formed in an inboard surface 31A of the mast 20. While FIG. 3 expressly depicts the mast 20A, it is understood that the mast 20B is essentially a mirror image thereof. In this regard, it can be understood that the inboard surfaces 31A and 31B of the two masts 20A and 20B, respectively, face one another and are in a confronting relationship.

The lift mechanism 22 is schematically depicted in FIG. 3. The lift mechanism 22 includes a motor 35 that is mounted on the chassis 6 and that is connected by a shaft 37 with a drive sprocket 33 that drives a lift chain 40. The lift chain 40 is connected with a pair of support blocks 38A and 38B (which may be individually or collectively referred to herein with the numeral 38), it being noted that the connection between the lift chain 40 and the blocks 38 is schematically depicted in FIG. 3. The motor 35 is operable to move the lift chain 40 to resultantly move the support blocks 38 within the interior region 28 of each mast 20 along the longitudinal extent of the masts 20. As will be set forth in greater detail below, the carriage assembly 24 is mountable to the support blocks 38, and it thus can be understood that movement of the lift chain 40 and the support blocks 38 results in movement of the carriage assembly 24 along the longitudinal extent of the masts 20.

As can further be seen in FIG. 3, the masts 20 each additionally include a pulley 32 upon which the lift chain 40 is movable. The pulley 32 is depicted in FIG. 3 as being mountable at the upper end of the mast 20A and being affixed thereto by a bolt 34 that is receivable in a threaded hole 36 that is formed in the mast 20A. It is understood that the mast 20B likewise has a similar pulley mounted at the top thereof upon which the lift chain 40 is movable. While the masts 20 in the depicted exemplary embodiment are not of a telescoping variety, it is understood that in other embodiments the masts 20 could be telescoping to provide lifting to higher positions along the vertical direction 18 without departing from the present concept. Such telescoping could be effectuated by the use of the lift chain 40 with additional pulleys or could be provided by a hydraulic cylinder that could separately lift the telescoping portion. Further variations will be apparent.

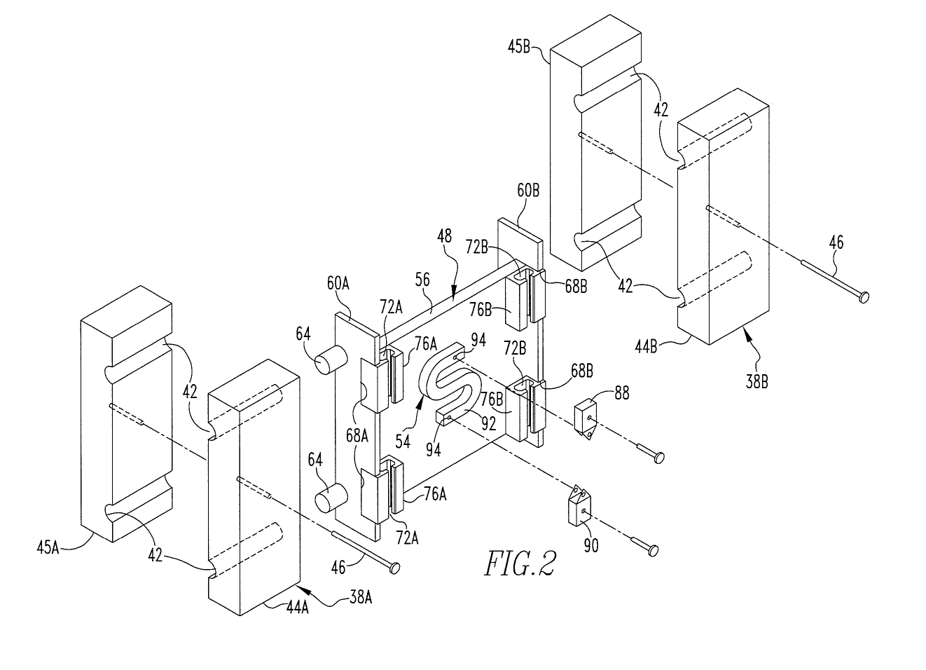

As can be understood from FIGS. 2 and 3, the support blocks 38A and 38B each include a first block half 44A and 44B, respectively, and each further include a second block half 45A and 45B, respectively. The support blocks 38 each include a pair of receptacles 42 that are formed therein and further include a fastener 46. One of the fasteners 46 is usable to clamp together the first and second block halves 44A and 45A of the support block 38A, and another fastener 46 is usable to fasten together the first and second block halves 44B and 45B of the support block 38B. Such fastening is done in order to secure within the receptacles 44 certain structures of the carriage assembly 24 in a fashion that will be set forth in greater detail below in order to mechanically connect together the carriage assembly 24 and the lift mechanism 22.

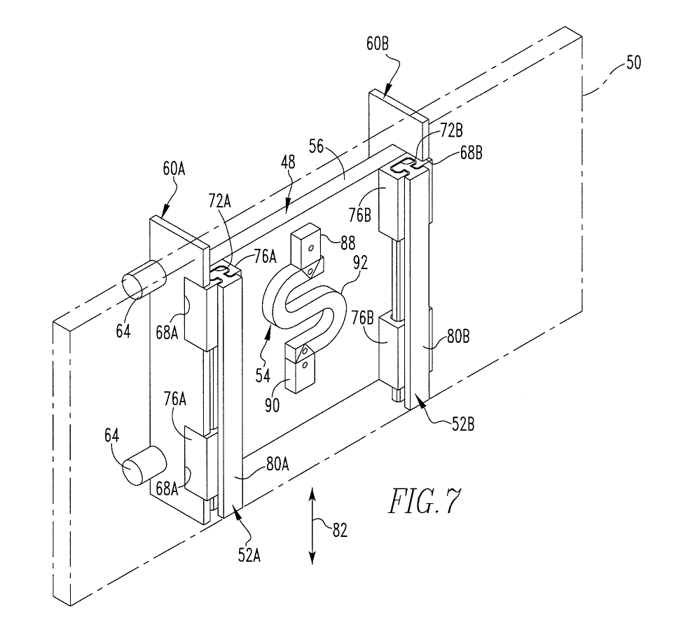

As is best shown in FIGS. 2 and 5-7, the carriage assembly 24 can be said to include a first support 48, a second support 50, a pair of linear motion bearings 52A and 52B (which may be individually or collectively referred to herein with the numeral 52) and a weighing apparatus 54. The first support 48 can be said to include a central plate 56 and a pair of side plates 60A and 60B that each have situated thereon a pair of lugs 64. The lugs 64 are receivable in the receptacles 42 to mount the first support 48 to the support blocks 38 and thus to the lift mechanism 22. It is understood, however, that the first support 48 can be mounted to the lift mechanism 22 in other fashions without departing from the present concept. For instance, the lugs 64 could be received in ball bearings or roller bearings or other types of bearings that are rollably situated in the interior regions 28 of the masts 20, by way of example. In such a situation, again by way of example, the lift chain 40 might be directly affixed to the central plate 56 and/or to the side plates 60A and/or 60B.

The first support 48 additionally has a pair of notches 68A formed in the side plate 60A and further has another pair of notches 68B formed in the side plate 60B. In the depicted exemplary embodiment, the side plates 60A and 60B (without notches 68A and 68B formed therein) are affixed to the central plate 56 to form a subassembly, and the notches 68A and 68B are then formed in the subassembly.

The linear motion bearing 52A includes a pair of first portions 76A that are received in the notches 68A and are affixed to the first support 48, and the linear motion bearing 52B likewise includes a pair of first portions 76B that are received in the notches 68B and are affixed to the first support 48. The first portions 76A each have a channel 72A formed therein, and the first portions 76B each have another channel 72B formed therein. The linear motion bearings 52A and 52B further each include a second portion 80A and 80B, respectively, and the second portions 80A and 80B are affixed to the second support 50.

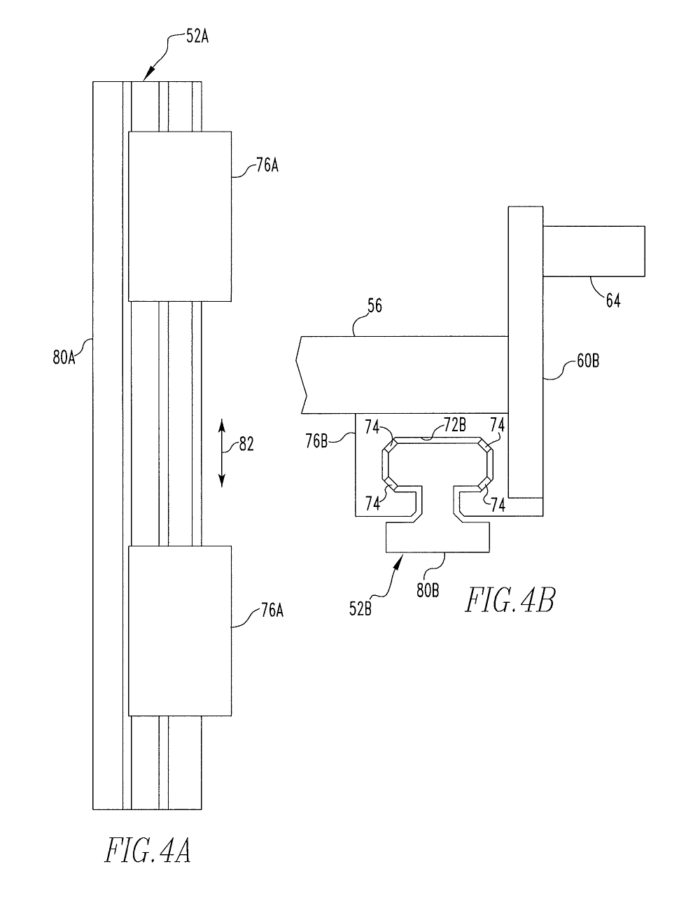

Furthermore, the linear motion bearings 52A and 52B each additionally include a set of rolling elements 74 that are rollably interposed between the first portions 76A and the second portion 80A in the case of the linear motion bearing 52A, and that are rollably interposed between the first portions 76B and the second portion 80B in the case of the linear motion bearing 52B. The exemplary rolling elements 74 that are depicted in FIG. 4B are cylindrical rollers, but they could alternatively or additionally include spherical or other-shaped rolling elements without departing from the spirit of the disclosed and claimed concept. The exemplary sets of rolling elements 74 are depicted herein as being free, meaning that they are not contained within a circulation cage, but it is understood that in other embodiments the rolling elements could be contained within a circulation cage without departing from the spirit of the disclosed and claimed concept.

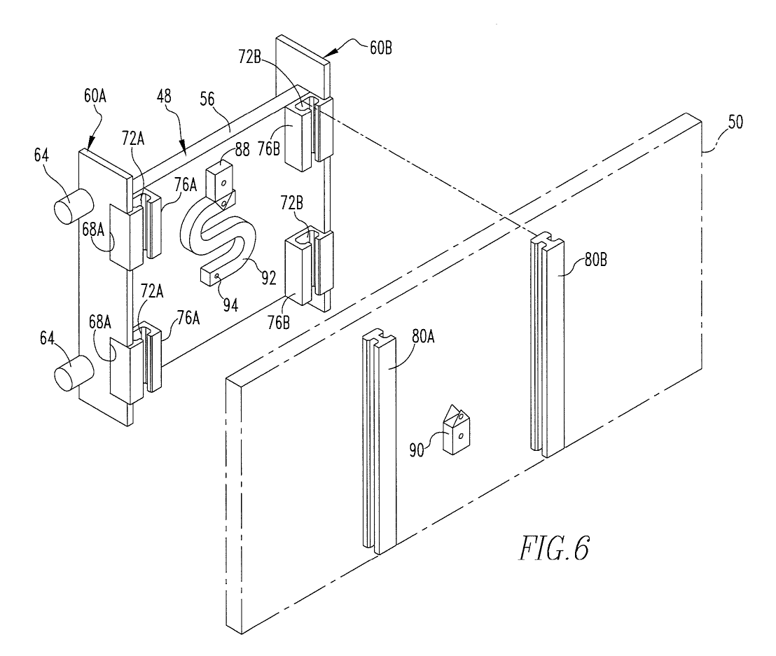

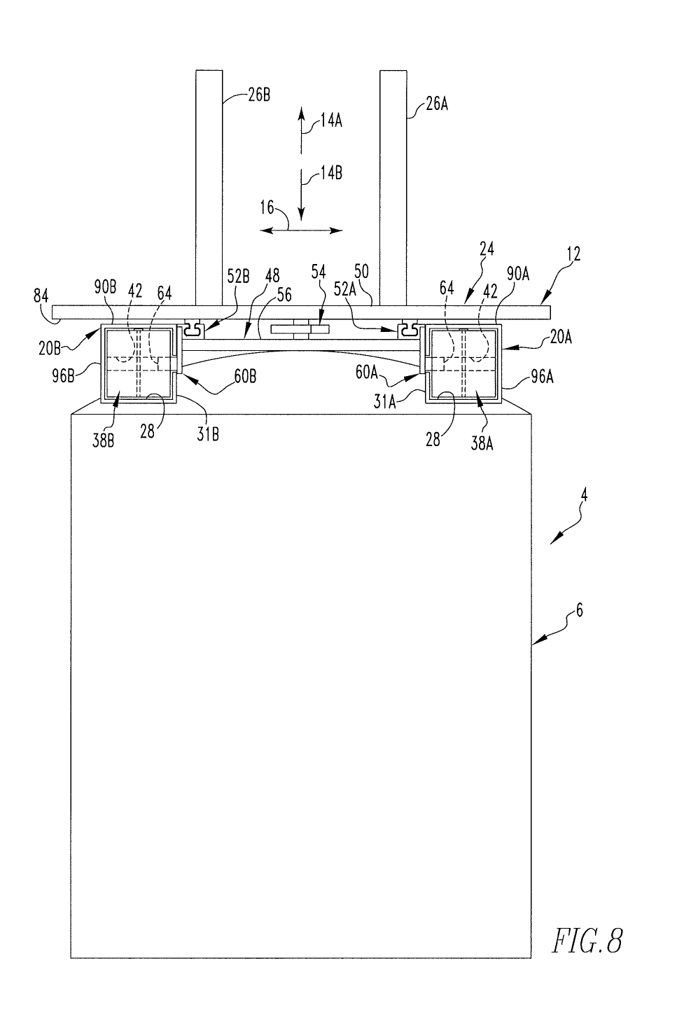

As can be understood from FIGS. 4A, 4B, and 8, the second portion 80A is receivable in the channels 72A (which are aligned with one another), and the second portion 80B is receivable in the channels 72B (which are likewise aligned with one another) with the rolling elements 74 being rollably interposed therebetween. It is noted that FIG. 6 depicts the linear motion bearings 52A and 52B in an exploded condition with the second portions 80A and 80B being removed from the channels 72A and 72B and without depicting the rolling elements 74.

The linear motion bearings 52 are mounted between the first and second supports 48 and 50 to permit relative motion therebetween along a movement direction 82 but to resist relative movement between the first and second supports 48 and 50 in any direction other than along the movement direction 82. The movement direction 82 is along the longitudinal extent of the second portions 80A and 80B, which are oriented parallel with one another. The linear motion bearings 52 could be, by way of example, a product sold by THK America, Inc. of Schaumburg, Ill., USA, and might be in the SHS Series and may be Model No. SHS-30L devices, although any appropriate device that can permit movement along one direction while resisting movement in other directions can be employed without departing from the present concept.

The linear motion bearing 52A is schematically depicted in FIGS. 4A and 4B and demonstrates that the second portion 80A is movable along the movement direction 82 with respect to the first portions 76A. It is understood that relative movement therebetween in directions other than along the movement direction 82 is resisted. As will be set forth in greater detail below, the linear motion bearings 52 permit the second support 50 to be moved along the movement direction 82 with respect to the first support 48, which enables the weighing apparatus 54, which is connected between the first and second supports 48 and 50, to accurately detect the loading thereon that results from the weight of the workpiece 2 situated on the forks 26. In this regard, it is understood that the forks 26 are exemplary in nature only and could be replaced with other structures such as clamps, barrel adapters, posts (such as would be received in and used to pick up rolls of carpet), hay spears, and any of a variety of other lifting attachments.

In the depicted exemplary embodiment, the first portions 78A and 78B are affixed in the notches 68A and 68B, respectively, such as by the use of welding or other attachment methodologies. The second portions 80A and 80B are affixed to a rear surface 84 of the second support 50, and such mounting can again be in any of a wide variety of fashions, such as via welding or through the use of threaded fasteners. By way of example, recessed slots could be formed in the rear surface 84, with the slots having a lower edge against which the lower ends of the second portions 80A and 80B could be received and which could provide support to the second portions in the vertical direction 18. This would reduce the clamping force that potentially would need to be provided to the second portions 80A and 80B to affix them to the rear surface 84 of the second support 50 if threaded fasteners are used.

As can be understood from FIG. 1, the second support 50 is a plate-like structure upon which the forks 26 are mounted. When the workpiece 2 is situated on the forks 26, the weight of the workpiece 2 applies a force to the forks 26 and thus to the second support 50 in the vertical direction 18, specifically in the downward vertical direction 18. Since the linear motion bearings 52 permit a certain degree of relative movement of the second support 50 in the plane of the second support 50 with respect to the first support 48, and specifically along the movement direction 82, the loading of the second support 50 by the weight of the workpiece 2 is communicated to the first support 48 via the weighing apparatus 54 that is connected between the first and second supports 48 and 50. Since the linear motion bearings 52 freely permit such movement of the second portion 50 with respect to the first portion 48 in the movement direction 82, the linear motion bearings 52 thus do not resist such movement between the first and second supports 48 and 50 in the movement direction 82, whereupon the loading of the second support 50 is accurately communicated to the weighing apparatus 54, which permits the weighing apparatus 54 to accurately reflect the weight of the workpiece 2.

As can be seen in FIG. 2, the weighing apparatus 54 can be said to include a first mount 88 that is affixed to the first support 48, a second mount 90 that is affixed to the rear surface 84 of the second support 50, and a load cell 92 having a pair of mounting holes 94 formed therein at its ends. One of the mounting holes 94 receives a corresponding structure on the first mount 88, and the other mounting hole 94 receives a corresponding structure on the second mount 90. The load cell 92 is connected by wires to a computerized system that detects inputs from the load cell 92 and that outputs a weight value for the workpiece 2. It is understood that the weighing apparatus 54 is depicted herein in an exemplary manner for purposes of illustration. In this regard, the load cell 92 could be any of a variety of load cells, and could alternatively be a compression load cell or a shear load cell, by way of example. Moreover, the weighing apparatus 54 could use multiple load cells if such would be suited to a particular application. For instance, it may be necessary to provide a plurality of load cells different locations between the first and second supports 48 and 50 in order to provide a high magnitude of load detection capability suited to the weight rating of the lift truck 4. Further by way of example, load cells having different weight detection ratings might be provided and alternatively switched ON and OFF depending upon whether a given load is known to fall within the rating detection rating of one load cell or another. Other variations will be apparent in the provision of a number of electromechanical force conversion devices in the weighing apparatus 54.

As can be understood from FIGS. 1 and 3, the masts 20A and 20B each further include an outboard surface 90A and 90B, respectively, opposite the inboard surfaces 31A and 31B, respectively. Additionally, the masts 20A and 20B can be said to each include a frontal surface 98A and 98B, respectively, that faces generally in the frontal direction 14A. The frontal surfaces 90A and 90B can be said to each extend generally between the inboard surfaces 31A and 31B, respectively, and the outboard surfaces 96A and 96B, respectively. As can be understood from FIG. 1, the frontal surfaces 98A and 98B can be said to be in a confronting relationship with the rear surface 84 of the second support 50. It can further be seen that the frontal surfaces 98A and 98B are directly adjacent the rear surface 84 of the second support 50, meaning that no structures are interposed between the rear surface 84 and the frontal surfaces 98A and 98B. In the depicted exemplary embodiment, the rear surface 84 is generally only minimally spaced away from the frontal surfaces 98A and 98B.

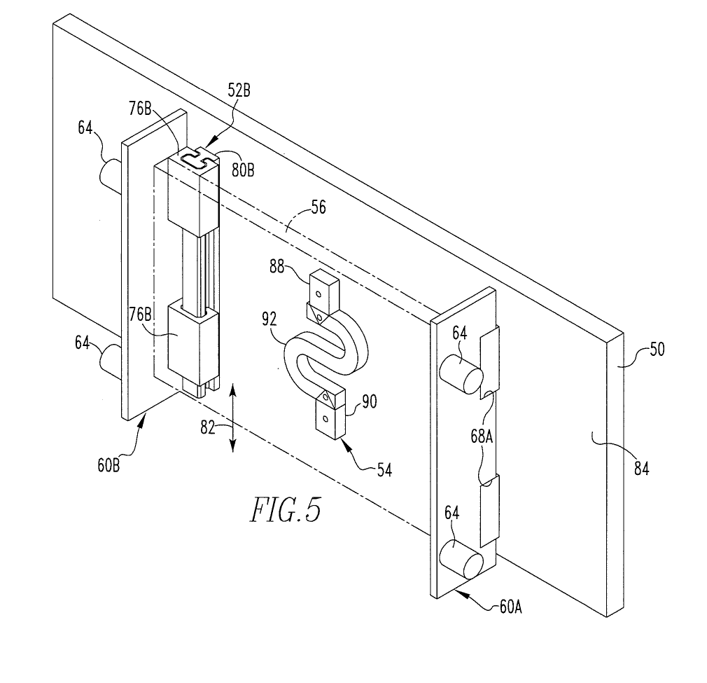

As can be understood from FIG. 5 and from the other figures presented herein, the central plate 56 and the side plates 60A and 60B are situated in their entirety between the outboard surfaces 96A and 96B. In this regard, the first support 48 is situated between the masts 20A and 20B, and it is understood that the lugs 64 extend through the slots 30 and into the interior regions 28 of the masts 20 and are connected with the support blocks 38 within the interior regions 28.

It can also be seen that the linear motion bearings 52A and 52B and the weighing apparatus 54 are each situated entirely or substantially entirely between the masts 20A and 20B. In this regard, it is understood that a small portion of the weighing apparatus 54 potentially may slightly protrude in the frontal direction 14A beyond the frontal surfaces 98A and 98B, such as a portion of the second mount 90 that is affixed to the rear surface 84 of the second support 50. Likewise, a small portion of the second portions 80A and 80B may protrude slightly forward of the masts 20 for affixation to the second support 50. However, it is expressly noted that nearly the entirety of the weighing apparatus 54 and nearly the entirety of the linear motion bearings 52A and 52B are situated in the rearward direction 14B from the frontal surfaces 98A and 98B.

Advantageously, this permits the weighing apparatus 54 to be integrated and self-contained within the carriage assembly 24, which has not previously been attempted. Previously known lift trucks have not included an integral scale, and thus aftermarket scale systems have been provided such as would have been mounted to the second support 50 in the absence of the advantageous weighing apparatus 54. As is generally understood in the relevant art, the provision of such a previously known weighing system in front of the second support 50 would additionally include a further frontal plate situated in the frontal direction 14A from the second support 50 to which the forks would be mounted. As such, the forks used in such a previously known scale apparatus would be situated forward in the frontal direction 14A from where they otherwise would have been situated upon initial manufacture, which is forward in the frontal direction 14A from where the forks 46 are depicted on the lift truck 4 in FIG. 8. Such retrofitting would require such a retrofitted lift truck to have its load rating reduced because of the dynamics of placing a load farther forward of a counterweight (such as is typically provided at the rear of a lift truck) than originally designed, which is undesirable. As has been known, the use of previously provided scale systems that would be retrofitted on the front of an existing lift truck would require the lift truck to originally be a much more expensive lift truck having a higher weight rating which would then be reduced due to the installation of the scale system on the front thereof. This was undesirably since it increased the cost of a retrofitted lift truck.

Advantageously, however, the second support 50 to which the forks 26A and 26B are mounted is no farther forward than would be the front plate of any other lift truck delivered from a manufacturer, yet the lift truck 4 has the weighing apparatus 54 incorporated therein and situated in the rearward direction 14B from the rear surface 84 and with the weighing apparatus 54 situated entirely or substantially entirely between the masts 20A and 20B. By providing the weighing apparatus 54 rearward of the second support 50, and with the second support 50 confronting and being directly adjacent the masts 20, the forks 26A and 26B need not be repositioned forward of where they are depicted in FIGS. 1 and 8 in order to accommodate a previously known weighing apparatus, such as would have been situated in the frontal direction 14A from the second support 50.

Advantageously, therefore, the weighing apparatus 54 can be incorporated into the lift truck 4 at minimal cost when compared with previously known systems that would have been mounted to the second support 50 of a preexisting lift truck. This avoids the need to reduce the weight rating of such a retrofitted lift truck, i.e., one retrofitted with a previously known scale. Likewise, it avoids the need to employ a higher cost lift truck having a higher weight rating that will subsequently need to be reduced after the retrofitting in order to achieve a predetermined level of weight rating on the retrofitted lift truck. This saves expense. It also reduces the use of additional material to provide a weighing function, thus reducing expense and weight.

While the lift truck 4 is depicted herein as being provided from the manufacturer with the weighing apparatus 54 integrated therein, it is understood that the carriage assembly 24 could be retrofitted onto an existing lift truck to form the lift truck 4. In so doing, such retrofitting operation would remove the structures that are situated between the existing lift mechanism and the forks and would be replaced with the carriage assembly 24.

The improved lift truck and retrofittable carriage assembly 24 thus provide enhanced features at significantly reduced cost. Other variations and advantages will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A lift truck comprising:
a chassis;
a pair of masts that are elongated and that are situated on the chassis, the pair of masts comprising a first mast and a second mast that are spaced apart from one another;
a lift mechanism situated on the chassis;
a carriage assembly situated on the lift mechanism and comprising a first support, a second support, at least a first linear motion bearing, and a weighing apparatus;
the first support being situated between the first mast and the second mast and being situated on the lift mechanism, the pair of masts permitting movement of the first support with respect to the pair of masts along the longitudinal extent of the pair of masts, the pair of masts at least partially resisting movement of the first support with respect to the pair of masts in directions other than along the longitudinal extent of the pair of masts;
a number of forks situated on the second support and being structured to carry a workpiece;
the at least first linear motion bearing comprising a first portion and a second portion, the at least first linear motion bearing permitting movement of one of the first portion and the second portion with respect to the other of the first portion and the second portion along a direction of movement, and the at least first linear motion bearing at least partially resisting movement of the one of the first portion and the second portion with respect to the other of the first portion and the second portion in directions other than along the direction of movement;
the first portion being affixed to the first support;
the second portion being affixed to the second support; and
the weighing apparatus comprising a scale that is connected with at least one of the first support and the second support and that is structured to be subjected to loading from the second support based at least in part upon a weight of the workpiece.

2. The lift truck of claim 1 wherein the first support and the second support are spaced apart from one another, the at least first linear motion bearing being situated between the first and second supports.

3. The lift truck of claim 1 wherein the direction of movement is a linear direction of movement that is oriented substantially parallel with the longitudinal extent of the pair of masts.

4. The lift truck of claim 1 wherein the first support extends between the first mast and the second mast.

5. The lift truck of claim 1 wherein the first mast has a first elongated interior region formed therein and wherein the second mast has a second elongated interior region formed therein, a first portion of the lift mechanism being movably situated within the first interior region, and a second portion of the lift mechanism being movably situated within the second interior region, the first support being affixed to the first and second portions of the lift mechanism.

6. The lift truck of claim 1 wherein the first support is interposed between the first mast and the second mast.

7. The lift truck of claim 1 wherein the scale is connected with the first support and the second support and comprises a tensile load cell that is subjected to tensile loading based at least in part upon the weight of the workpiece.

8. The lift truck of claim 1 wherein the scale is situated between the first support and the second support.

9. The lift truck of claim 8 wherein the scale is situated between the first mast and the second mast.

10. The lift truck of claim 9 wherein the second support is situated adjacent the first mast and the second masts and protrudes beyond both the first mast and the second mast in an outboard direction transverse to the longitudinal extent of the pair of masts.

11. The lift truck of claim 1 wherein the first mast has a first outboard surface and wherein the second mast has a second outboard surface, the first and second outboard surfaces facing generally away from one another, the first support being situated substantially entirely between the first and second outboard surfaces.

12. The lift truck of claim 11 wherein the number of forks protrude from the second support in a frontal direction with respect to the chassis, and wherein the first mast has a first frontal surface and wherein the second mast has a second frontal surface, the first and second frontal surfaces facing generally toward the frontal direction, the second support being situated adjacent the first and second frontal surfaces.

13. The lift truck of claim 12 wherein the second support comprises a rear surface that faces generally toward the first support, at least a portion of the rear surface being in a confronting relationship with at least a portion of each of the first and second frontal surfaces.

14. The lift truck of claim 12 wherein the second support comprises a rear surface that faces generally toward the first support, at least a portion of the rear surface being situated directly adjacent at least a portion of each of the first and second frontal surfaces free of other structures being situated therebetween.

15. The lift truck of claim 1 wherein the first support is an at least partially plate-like structure.

16. The lift truck of claim 1 wherein the second support is an at least partially plate-like structure.
